(19) United States
(12) Patent Application Publication
(10) Pub. No.: US 2014/0062687 A1
(43) Pub. Date: Mar. 6, 2014

(54) INTERACTIVE AND DIRECT TRANSMISSION OF DATA FROM SIGNS AND BILLBOARDS

(71) Applicant: Michael Voticky, Austin, TX (US)

(72) Inventor: Michael Voticky, Austin, TX (US)

(21) Appl. No.: 13/597,023

(22) Filed: Aug. 28, 2012

(51) Int. Cl. G08B 5/00; H04W 64/00

(52) U.S. Cl. 340/438; 455/456.3

(57) ABSTRACT

Provided are techniques for receiving a message from a user device; calculating the location and heading of the user device; correlating the location of the user device with any advertising or information display device in proximity to the user device; correlating a product with the display device; generating a second message with information stored in conjunction with the display device; and transmitting the second message to the user device. In one embodiment, a third message may be generated comprising an acceptance of an offer corresponding to the first or second message. In one embodiment, a vehicle or consumer may transmit diagnostic information and received information pertaining to businesses that can address an issue related to the diagnostic information. In one embodiment, a vehicle or consumer may transmit consumer and location information to register for a resource such as a parking spot that is related to a resource.

### FIELD OF DISCLOSURE

The claimed subject matter relates to techniques for interactive and direct delivery of information and offers from display devices such as signs and billboards.

### SUMMARY

Provided are techniques for the interactive and direct transmission of information, including, but not limited to, pre-stored and pre-defined information, to and from display devices, viewable by the public or clients of a business or other organizations, such as signs and billboards. Examples of pre-stored information include, but are not limited to, coupons and contact information such as email addresses, telephone numbers and websites. Examples of pre-defined information include alerts such as directions, speed limits, low overpass warnings, tolls to be paid and so on. A typical display device such as a billboard or a sign delivers visual information about directions, products or services. Throughout this Specification the terms display devices, billboard and sign are used interchangeably to indicate an information source that is typically displayed in a public place, including but not limited to, multi-faced, duplex boards and multiple displays in close proximity, or “clusters.” It should be noted that public places may be indoor, outdoor in subway terminals and so on. The terms “reader” or “consumer” are used to indicate a recipient of information from a sign, billboard, pylon or towers. The terms “customer” and “business” are used to indicate an entity such as, but not limited to, retail businesses, service businesses, manufacturers, distributers, non-profits, political organizations, charities and commercial establishments, and governmental agencies that employs the disclosed technology to communicate with consumers.

Highways and roads are lined with businesses that rely upon travelers, or consumers, for business. In addition, governmental agencies rely upon roadside display devices to deliver messages such as, but not limited to, detours, current or upcoming speed limits, heights of upcoming overpasses and so on. Display devices include, but not limited to, billboards, signs, pylons, and video display, some of which may be mobile such as blimps and signs towed behind airplanes and mounted on vehicles. The claimed subject matter also applies to clusters of display devices.

With respect to businesses, many have perishable assets. Examples of such perishable assets include, but are not limited to, a hotel room that generates no income if left empty and underutilized occupancy at an amusement park. Although a gas station that does not sell fifty (50) extra gallons one day may sell the gasoline the next day, a day's gross sales and profit may go up if the 50 extra gallons are sold sooner rather than later.

One technique for the maximization of revenue and gross profit margins is yield management. Many hotel/motels sell block or discounted rooms to third parties as well as adjusting their remaining inventory and/or price as often as hourly. However even after such bulk sales, a hotel may rely upon “drive-by” or “walk-in” business, potentially at lower than published rates, particularly if the hotel/motel has a surplus of empty rooms as the night progresses. In addition, offers may be time dependent such as “valid for one hour.”

Another issue that may be addressed by the disclosed technology is the coordination of a business's parking spaces. Many businesses have parking issues due to surrounding establishments and events that are in need of parking. As a result, non customers may use spaces meant for a particular business's patrons. By linking a particular parked car to a patron in for example a particular hotel room or restaurant table or seat, a business may be able to determine if a space reserved for patrons is being used appropriately and take appropriate measures if not. Further, the disclosed technology may enable a vehicle with a displayed or audible warning such as, but not limited to, low gas or tire pressure, low battery and lights out to be provided information on nearby locations (e.g., a gas station with an air pump) that are able to address the issue (e.g., low tire pressure), thereby enabling a user to find appropriate service within their range and then select, receive directions and drive to a particular business or location to address the issue.

Briefly, provided are techniques for receiving a first message from a first mobile device; calculating a location and heading of the device based upon the first message; correlating the location and heading of the device with a display device in proximity to the device; generating a second message, based upon stored data associated with the display device, comprising to one or more of a data list, the data list comprising: information corresponding to the display device; information corresponding to a product; information corresponding to a service; a location of an entity corresponding to the display device; and an offer associated with a one or more of the product, service and information corresponding to the display device; wherein the entity is one of an entity list, comprising; a business; a service; a non-profit organization; and a governmental agency; and transmitting the second message for display to a user associated with the device.

In another embodiment, provided are techniques for receiving a first message from a device associated with a vehicle, wherein the first message includes information relating to a current condition of the vehicle; calculating a location and heading of the vehicle based upon the first message; correlating the location and heading of the vehicle with a location of one or more businesses in proximity to the vehicle, wherein the businesses are capable of addressing, the current condition of the vehicle; generating a second message comprising an identity of the businesses; and transmitting the second message for display to a user corresponding to the vehicle.

In another embodiment, provided are techniques for registering a vehicle with a business; correlating, based upon the registering, the vehicle with a resource associated with the business; monitoring usage of the resource with respect to the vehicle; detecting that the usage has exceeded a predetermined limit; and in response to the detecting, notifying the business, a consumer or third party that the usage has exceeded the predetermined limit.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the an upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is an illustration of a Product and Information Delivery (PAID) architecture in which the claimed subject matter may be implemented.

FIG. 2 is an illustration of the PAID architecture of FIG. 1 showing specific examples of some elements.

FIG. 3 is a block diagram of a PAID server (PAIDS) that may implement aspects of the claimed subject matter.

FIG. 4 is a flowchart of one example of a PAIDS Setup process that may implement aspects of the claimed subject matter.

FIG. 5 is a flowchart of a one example of an Operate PAIDS process that may implement aspects of the claimed subject matter.

FIG. 6 is a flowchart of one example of a Generate Offer process that may implement aspects of the claimed subject matter.

FIG. 7 is a flowchart of a Sensor Detection process that may implement aspects of the claimed subject matter.

FIG. 8 is a flowchart of a Parking Control process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, cloud data storage, a thumb drive or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RP, UHF, Wi-Fi, Bluetooth etc., or any suitable combination of the foregoing.

Computer program code for carrying out operations for aspects of the present invention may be written in any combination of one or more programming languages, including an object oriented programming language such as JAVA®, Smalltalk, C++ or the like and conventional procedural programming languages, such as the “C” programming language or similar programming languages. Different portions of program code may execute entirely on the user's computer, partly on the user's computer, as a standalone software package, partly on the user's computer and partly on a remote computer or entirely on the remote computer or server In the latter scenario, the remote computer may be connected to the user's computer, telephone, smart device, onboard display through any type of network, including a wireless telephone network, local area network (LAN) or a wide area network (WAN), or the connection may be made to an external computer (for example, through the Internet using, an Internet Service Provider). In the context of this disclosure, the terms “computer” and “computing device” may include, but are not limited to, any device, including mobile devices, that includes memory and a processor, including telephones, onboard automotive devices, laptop computers, radios, computing eyewear, personal digital assistants (PDAs), tablet computers and so on.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted, that although the claimed subject matter is described in conjunction with billboards, wireless communication and a mobile computing device in an automobile, the claimed subject matter is applicable to many type of advertising devices, communication media and user devices. For example, in addition to billboards, any advertising display device may be employed, including but not limited to, signs, pylons, and video displays. Communication media includes, but is not limited to, RE and UHF transmitters and receivers, cellular devices, Bluetooth, satellite communication and Wi-Fi. Mobile computing devices may include, but are not limited to, cellular telephones, tablet, notebook and laptop computers. Wi-Fi enabled computer and display eyewear.

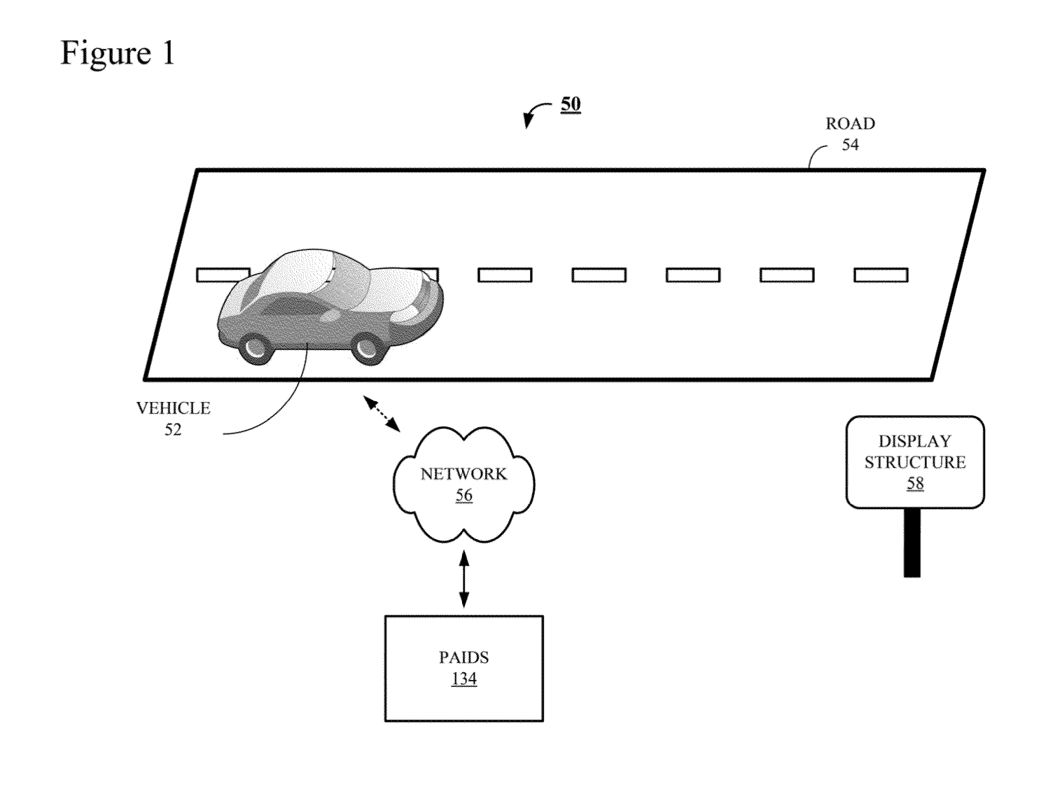

Turning now to the figures. FIG. 1 is an illustration of a Product and Information Delivery (PAID) architecture 50 in which the claimed subject matter may be implemented in accordance with one embodiment of the disclosed technology. A vehicle 52 on a road 54 is communicatively coupled to a network 56. Network 56 may be, but is not limited to, a local area network (LAN), a wide area network (WAN), a circuit switched telephone network, a Global System fir Mobile Communications (GSM) network, a Wireless Application Protocol (WAP) network, a WiFi network, an IEEE 802.11 standards network or various combinations of the above networks.

A PAID server (PAIDS) 134 is configured to provide information displayed on a display structure 58, including, but not limited to, video and alphanumeric information about a product or service that may be advertised. Such information about a product or service may include, but is not limited to, pricing (which may vary depending upon such factors as time of day and type of vehicle 52), contact information associated with a business, organization or governmental entity corresponding to the information on display structure 58, ordering information, website information (e.g., a Uniform Resource Locator, or “URL”), electronic coupons and so on. Display structure 58 is positioned on road 54 for the benefit of occupants of vehicle 52 and may be, but is not limited to, an outdoor advertising structure such as a billboard or sign. Display structure 58 may be painted, digital, three-dimensional, inflatable, rotatable, and so on. In addition, display structure 58 may be indoor, outdoor, underground, examples of locations include, but are not limited to, a shopping mall, arena, stadium, airport, railway station, train stop, on a moving bus, train, subway, tram, or airplane, as well as in a store, restaurant, bar, underground in a subway station, gas station pump, bus shelter, a below surface shopping structure, or a parking garage below or above ground and so on.

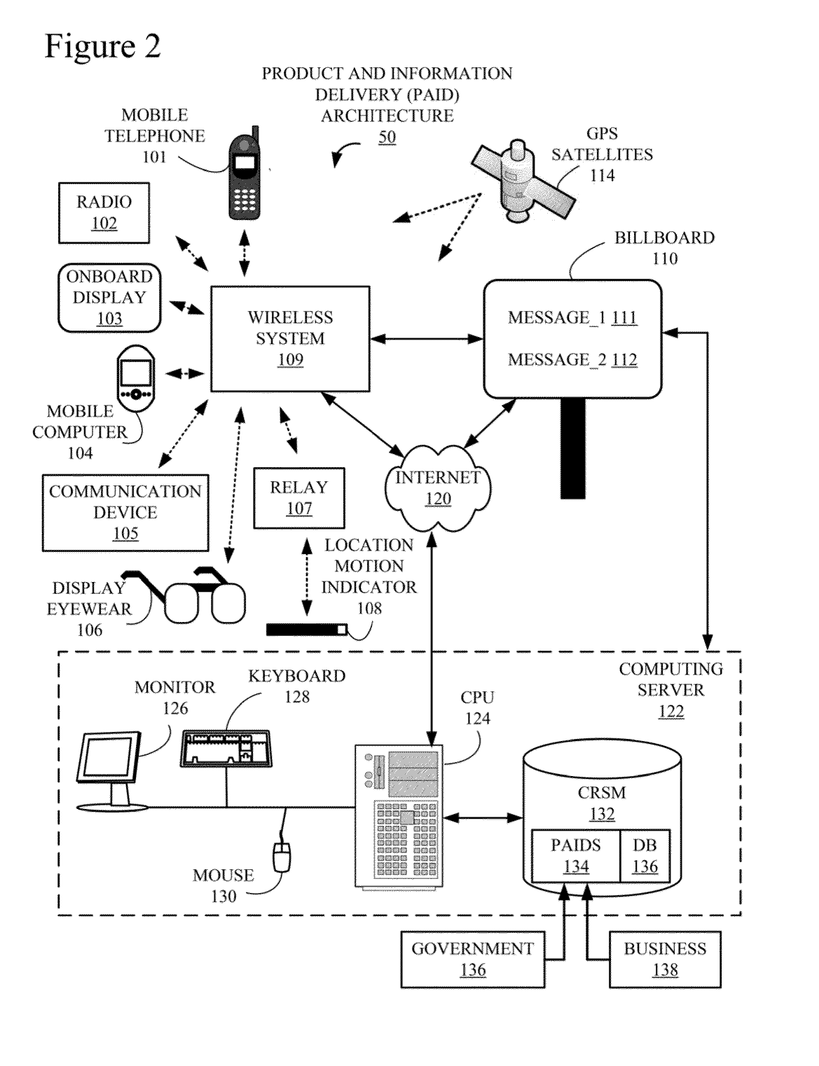

As described in more detail below, PAIDS 134 provides additional information corresponding to the information displayed on display structure 58. Various components that may implement aspects of the claimed subject matter and several ways in which the system may be employed are described in more detail below in conjunction with FIGS. 2-8.

FIG. 2 is an illustration of Product and Information Delivery (PAID) architecture 50 of FIG. 1 showing specific examples of elements that may support the transmission and reception of data associated with the disclosed technology. It should be understood that the following examples are used for illustrative purposes only and are not intended to limit the either the scope or implementation of the claimed subject matter.

A mobile telephone 101, a radio 102, an onboard display 103 (such as those typically found in many current automobiles and trucks), a mobile computer 104, a two-way onboard communication device 105 (e.g. ONSTAR® and Lexus Link®), display eyewear 106 and a relay 107, which works in conjunction with any of the other devices and/or a location and/or motion indicator 108, are configured to operate in conjunction with a wireless system 109. Wireless system is used as one example of a communication device employed to communicate with the internet 120, which is one example corresponding to network 56 (FIG. 1). It should be understood that mobile devices 101-108 are only some examples and there are others both currently in use and yet to be developed in which the disclosed technology may be applicable such as but not limited to wireless headsets, motion based sensors and wireless location indicators such as wands. In addition, devices such as a wand or telephone 101 may be configured to transmit “air written” information, e.g., characters or pointing motions generated by moving the device in the air, or via air writing. Each of these devices may be used in conjunction a vehicle such as a scooter (not shown), bicycle (not shown), vehicle 52 (FIG. 1) or employed by a pedestrian. It should also be understood that sonic of devices 101-108 may be capable of two-way communication that enables additional functionality for the claimed subject matter. For example, an onboard vehicle communication system such as ONSTAR® or and Lexus Link® includes a transmitter that would be able to communicate computer diagnostic information relating to a user's vehicle. Using, such computer diagnostic information, such as, but not limited to, fuel, oil, tire pressure, and battery charge warnings, the disclosed technology may direct a consumer to a business that is able to service a specific need.

A device such as indicator 108 may be, but is not limited to, a wand, pointer or shake device that transmits location, motion and/or position information to relay 107. In addition to indicator 108, mobile telephone 101 may employ current or yet to be developed location/motion/shake detection capabilities to implement the disclosed technology. For example, some mobile telephones may enable a user to designate a display device by pointing the telephone at the display device or writing a code associated with the display device in the air with the telephone. A link between relay 107 and indicator 108 or any of devices 101-106 may be any currently available or yet to be developed transmission mediums such as Wi-Fi or Bluetooth. In addition to transmitting the information from indicator 108 to wireless system 109, relay 107 may include location determination functionality. Relay 107, may determine a geographical location and, in correlation with position information from indicator 108, determine a particular display device. Relay 107 may work in conjunction with any of devices 101-106 and 108 to include functionality so that a response from a query is directed to a different device than the source of the query. For example, a query from display eyewear 106 or indicator 108 may be configured to receive a reply at onboard display 103. In addition, indicator 108 may be simply a user's finger or area in that relay 107 makes a determination of location and/or motion simply by visually calculating how the finger or arm points and or moves or by tracing the movement to determine a alphanumeric code or alias name for billboard 110.

Also communicatively coupled to wireless system 109 is an advertising display device, i.e. a billboard 110, which is used as one example of a display structure such as display structure 58 (FIG. 1). Billboard 110 is used for illustrative purposes; some additional devices that may implement aspects of the claimed subject matter include, but are not limited to, traffic signs, warning signs and pylons and displays that present information to mobile consumers, including, but not limited to, passengers and drivers in vehicles, pedestrians and passengers of common carriers. Billboard 110 is illustrated displaying two (2) messages to public viewers, i.e. a message_{—}1 111 and a message_{—}2 112. Messages 111 and 112 are used only for illustrative purposes and the specific number of messages is not relevant to the disclosed technology. Transmitting location information into PAID architecture 50 are global positioning system (GPS) satellites 114. Location information may also be transmitted in the form of a pre-defined alphanumeric code or alias correlated with a particular location and displayed in conjunction with billboard 110. Rather than displayed, location information may also be transmitted wirelessly from billboard 110 to a receiving device such as devices 101-108.

Wireless system 109 and billboard 110 are communicatively coupled to the Internet 120, which is also coupled to a computing server, or simply “server,” 122. Although in this example, wireless system 109, billboard 110 and server 122 are communicatively coupled via the Internet 120, they could also be coupled through any number of communication mediums such as, but not limited to, a local area network (LAN) (not shown), direct wires, the public telephone system and devices that employ radio frequencies such as, but not limited to, Bluetooth, satellite communication, Wi-Fi and UHF.

In the example, server 122 includes a central processing, unit (CPU) 124 with one or more processors (not shown), coupled to a monitor 126, a keyboard 128 and a pointing device, or “mouse,” 130, which together facilitate human interaction with server 122 and other components of PAID architecture 50. Also coupled to server 122 and attached to CPU 124 is a computer-readable storage medium (CRSM) 132, which may either be incorporated into client system 122 i.e. an internal device, or attached externally to CPU 124 by means of various, commonly available connection devices such as but not limited to, a universal serial bus (USB) port (not shown). CRSM 132 is illustrated storing a computer application that incorporates the claimed subject matter, i.e. a PAID Server (PAIDS) 134. PAIDS 134 is coupled to a database (DB) 136. As described in more detail below, PAIDS 134 interacts with other components of PAID architecture 50, including PAID agents (PAIDA) (not shown) that are logic executing on devices such as devices 101-108.

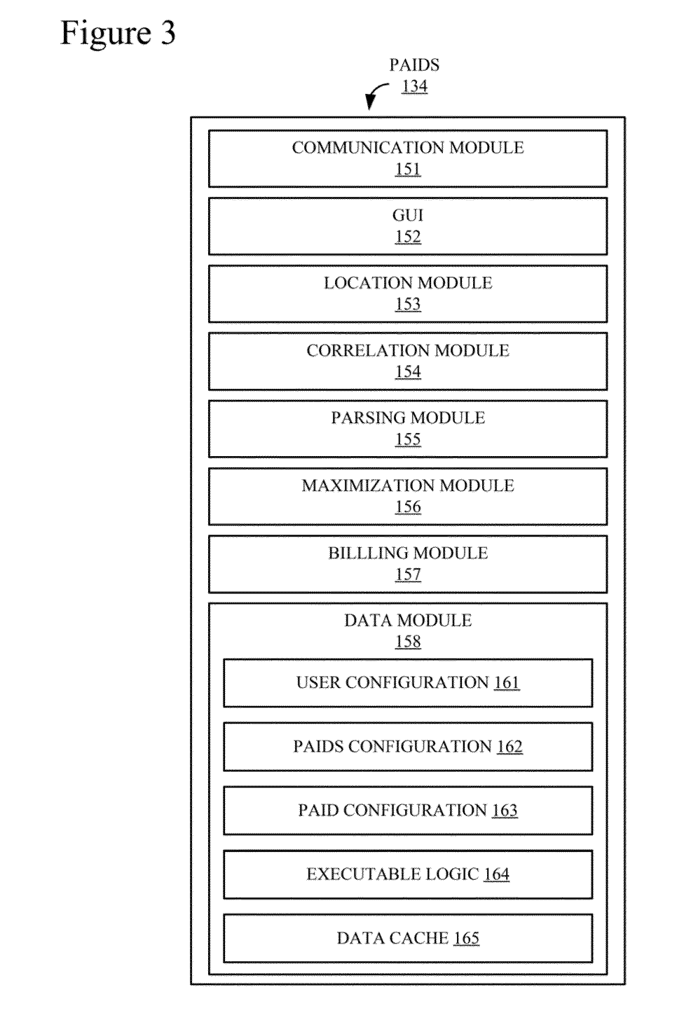

Also illustrated are entities that may provide input to PAIDS 134, including governmental entities 136 and businesses 138. Governmental entities 136 may provide information such as the location of road closings, detours, hazards and so on as well as links to websites. Businesses 118 may enter data on products and services, websites, email addresses, directions, prices, sales, coupons and so on. It should be noted there are many possible configurations that may implement the claimed subject matter, of which PAID architecture 50 is only one simple example. The components of PAID architecture 50 in FIG. 2 are described in more detail below in conjunction with FIGS. 3-8.

FIG. 3 is a block diagram of PAIDS 134, first introduced above in conjunction with FIGS. 1 and 2, in more detail. In this example, logic associated with PAIDS 134 is stored on CRSM 132 (FIG. 2) and executed on one or more processors associated with CPU 124 (FIG. 2) of server 122 (FIG. 2). PAIDS 134 includes a communication module 151, a graphical user interface (GUI) 152, a location module 153, a correlation module 154, a parsing module 155, a maximization module 156, a billing module 157 and a data module 158.

Communication module 151 provides means for PAIDS 134 to communicate with other components of server 122 and PAID architecture 50 (FIGS. 1 and 2). As explained above, almost any type of communication medium may be employed, including, but not limited to, RF, UHF, Bluetooth, satellite communications, public wired and wireless systems, microwave and so on.

GUI 152 provides a user interface for administrators, governmental entitles 136 (FIG. 1), businesses 138 (FIG. 2) and any other users with permission to access the system. GUI 152 may also be employed to enter pre-stored and pre-defined information corresponding to products, services, offers, coupons associated with any particular display device. Communication module 151 also includes logic to correlate the positions of different entities, for example, after determining the location and heading of a vehicle or mobile device.

Location module 153 determines the location of display devices such as billboard 110 (FIG. 2) and devices such as mobile devices 101-108 (FIG. 2). Although, many display devices may be in a fixed position such that data may simply be stored in and retrieved from DB 136 (FIG. 2), the disclosed technology also includes provisions for mobile display devices such as moveable warning signs and mobile advertising vehicles. In addition to location, direction of travel, or “heading,” and predictions of possible paths may also be generated by location module 153 using any currently available or yet to be developed technology. Examples of such technology include, but are not limited to the Global Positioning System (GPS) information transmitted by GPS satellites 114 (FIG. 2) and triangulation based upon multiple signals to various communication facilities such as cellular telephone towers. In addition, location information may be determined based upon a location code displayed on the display device, based upon displayed information such as a highway mileage marker or highway exit, or transmitted wirelessly from the display device to a device such as mobile devices 101-108.

Correlation module 154, using information generated by location module 153 matches devices such as devices 101-108 with display devices such as billboard 110. For example a vehicle with onboard display 103 may be traveling near a billboard that faces two directions. In that case, the location and direction of travel may both be relevant to make a determination as to which billboard face is visible to the driver. Further, a billboard many be one of a cluster of billboards such drat a particular billboard within the cluster many be identified by means such as an audible command, pointing a device at the particular billboard or entering a code corresponding to an alias for that particular billboard.

Parsing Module 155 includes logic for translating voice and text messages into queries and translating replies into voice and text messages. In addition, parsing module 155 may interpret an image captured by a user's device, translating the image into data that can be correlated to a particular sign or message. Maximization module 156 includes logic for implementing profit maximization algorithms that can generate terms for a requested deal based upon such factors as time of date and availability of a product or service. Billing Module 157 generates invoice information for both travelers (to pay for purchased products) and business (to pay for the advertising, possibly on a per-hit or commission basis). Other factors that be taken into consideration by billing module 157 are coupons, pre-paid deals and the calculation of any potential commissions.

Data Module 158, which stores logic and data used in processing, includes sections on user configuration 161, PAIDS configuration 162, a PAID architecture configuration 163, executable logic 164 and a data cache 165. User configuration 161 stores data on governmental entities 136 (FIG. 2) and businesses 138 (FIG. 2) that employed the disclosed technology to communicate with customers and users that are the target of informational messages. In other words, in the following examples, a “user” is any entity that communicates via PAID architecture 50. Examples may include a hotel, which may store data on location, room availability and pricing, a governmental agency, which stores information on hazardous weather conditions or alternative routes corresponding to a detour around road construction, and a gas station, which stores information on the availability and price of certain products. Additional information may include price change times, potential coupons, frequent user/loyalty/rewards cards or points, discount codes and maximization schemes employed by maximization module 156, a physical address, an email address, a contact person, a telephone number, credit card information, latitude, longitude, auto change time, auto change date, audio, visual and textual messages, web site and so on.

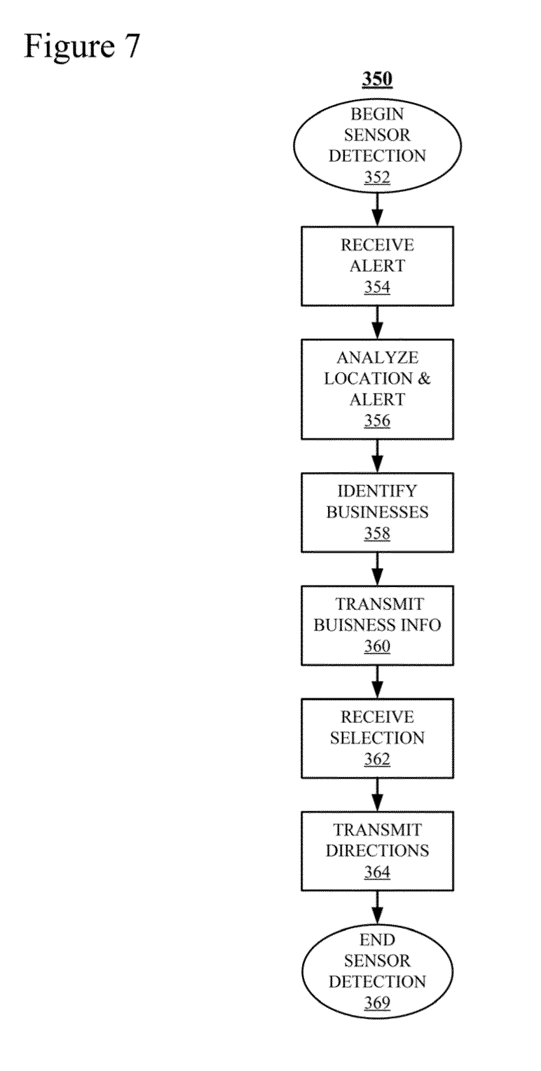

In addition, user configuration 161 may include information on consumers that utilize the system. Information may be included to indicate the configuration of a particular consumer. For example, a consumer using a location/motion detection device (see 108, FIG. 2) may need a transmission to a different device such as an onboard display (see 103, FIG. 2). It should be noted that a response to a query is not necessarily transmitted to the source of the query. In addition, user preferences may be stored. For example, a user may register a preference for a particular type or brand of hotel or gas station (see 358, FIG. 7).

PAIDS configuration 162 stores parameters for controlling the operation of PAIDS 134. Examples may include, but are not limited to, timeout values, data entry conventions, default values and display messages and storage options. PAID configuration 163 stores information on components that may be incorporated into PAID architecture 50, including parameters for controlling and communicating with devices 101-108 and display devices such as billboard 110. Executable logic 164 stores the programming code for implementing the functionality of the claimed subject matter. Data cache 165 stores the results of ongoing processing. One example of information stored for the purposes of ongoing processing may be a user's route information. For example, a user may enter a starting point, an ending point and particular items of interest. PAIDS 134 may then utilize this information to notify the user about particular businesses, warnings, goods, services and attractions and other information as the user's vehicle comes within range. Functionality may also be added to inform a user, in addition to particular businesses, warnings, goods, services and attractions on the way to a particular destination, that the particular destination has been reached.

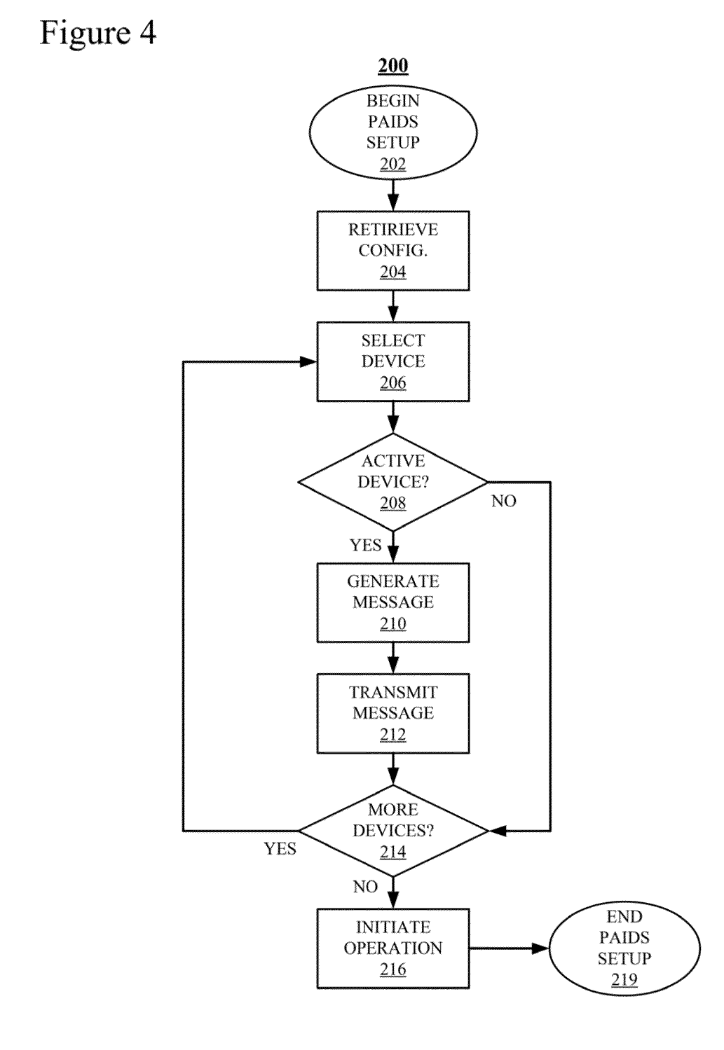

FIG. 4 is a flowchart of one example of a PAIDS Setup process 200 that may implement aspects of the claimed subject matter. In this example, process 200 is stored in executable logic 164 (FIG. 3) in conjunction with PAIDS 134 (FIGS. 1-3) on CRSM 132 (FIG. 2) of server 122 (FIG. 2) and executes on one or more processors (not shown) of CPU 124 (FIG. 2).

Process 200 starts in a “Begin PAIDS Setup” block 202 and proceeds immediately to a “Retrieve Configuration (Config.)” block 204. During processing associated with block 204, process 200 retrieves information from DB 136 (FIG. 2) concerning the configuration of PAID architecture 54) (see 163, FIG. 3), PAIDS 134 (see 162, FIG. 3) and the businesses that employ the claimed subject matter (see 161, FIG. 3). As explained above in conjunction with FIG. 3, information concerning PAID architecture 50 and users of PAID architecture 50 includes information about the display devices such as billboard 110 (FIG. 2) that may be subject to the disclosed technology, either because they are controlled by PAIDS 134, i.e. active, or because information concerning them is stored in DB 136 and used to generate offers and respond to queries on behalf of the corresponding users, i.e., passive. It should be noted that both active and passive display devices may be the subject of queries and offers in accordance with the claimed subject matter.

During processing associated with a “Select Device” block 206, a display device such as billboard 110 is selected from a list of display devices subject to the disclosed technology as determined from the configuration retrieved during processing associated with block 204. The particular device selected during any particular iteration through process 200 is referred to as the “current” device. During processing associated with an “Active Device?” block 208, a determination is made as to whether or not the device selected during processing associated with block 206 is active, i.e. controlled by PAIDS 134, or passive, i.e. information about the sign is stored and the stored information is employed to respond to queries and generate and accept offers for the user corresponding to the display device.

If the current display device is active, during processing associated with a “Generate Message” block 210, a message is generated for the current display device (see 110, 111 and 112, FIG. 2). The particular message generated may depend upon factors such as, but not limited to, the time of day, the availability and price of products, the existence of a need to inform or warn a viewer or the display device and so on. Of course, the user associated with the display device would typically be responsible for specifying the particular messages and the conditions under which any particular message would be displayed. During processing associated with a “Transmit Message” block 212, the message generated during processing associated with block 212 is transmitted to the current display device and posted by the display device. In addition, the message may be for example transmitted to an audio device, tested to a predefined device or emailed to a predefined email address.

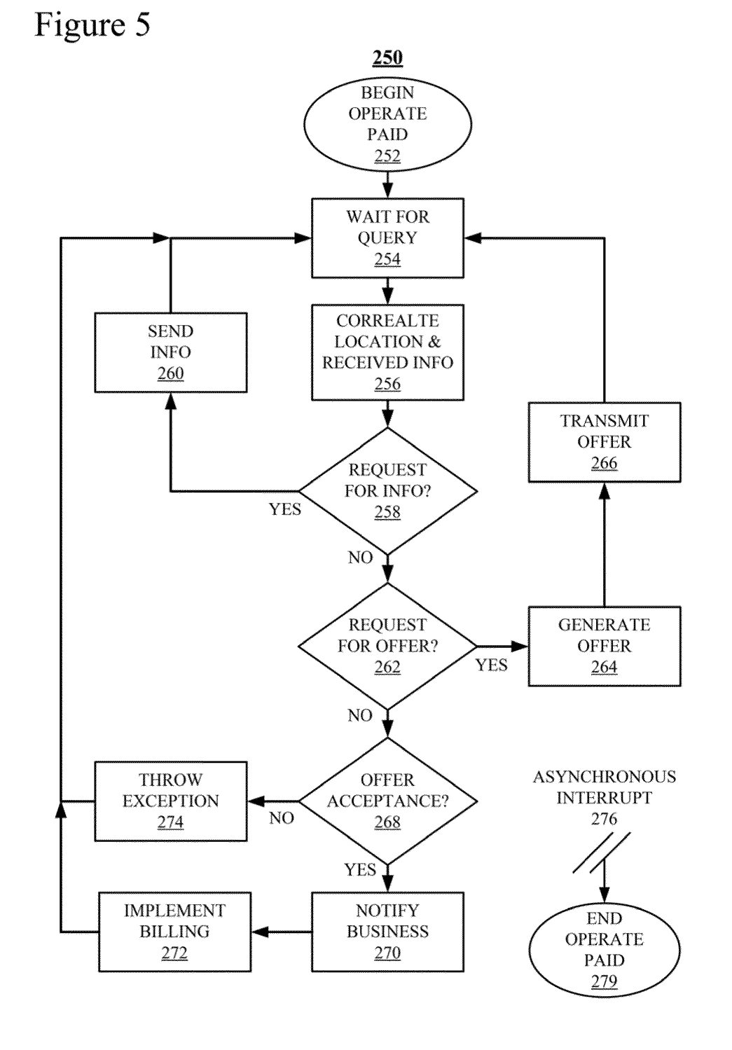

Once a messaged has been transmitted during processing associated with block 212 or a determination has been made during processing associated with block 208 that the current display device is passive, control proceeds to a “More Devices?” block 214. During processing associated with block 214, a determination is made as to whether or not there are any additional display devices to process and/or configure. If so, control returns to block 206, the next display device is selected and processing continues as described above. If not, control proceeds to an “Initiate Operation” block 216. During processing associated with block 216, an Operate PAID process is spawned to process queries, requests and offers as they are generated by viewers of the display devices (see 250, FIG. 5). Finally, control proceeds to an “End PAID Setup” block 219 during which process 200 is complete.

FIG. 5 is a flowchart of a one example of an Operate PAIDS process 250 that may implement aspects of the claimed subject matter. Like process 200, in this example, process 250 is stored in executable logic 164 (FIG. 3) in conjunction with PAIDS 134 (FIGS. 1-3) on CRSM 132 (FIG. 2) of server 122 (FIG. 2) and executes on one Or more processors (not shown) of CPU 124 (FIG. 2).

Process 250 starts in a “Begin Operate PAID” block 252 and proceeds immediately to a “Wait for Query” block 254. During processing associated with block 254, process 250 waits for a query form a mobile device such as mobile devices 101-108 (FIG. 2). Such as query is typically initiated in response to a user responding via one or more first messages to a displayed message observed on a display device and transmitted via one of the mobile devices illustrated above in conjunction with FIG. 2. In this example, a user from an automobile (not shown) with onboard display 103 (FIG. 2) observes messages 111 and 112 (FIG. 2) displayed on billboard 110 (FIG. 2). During processing associated with a “Correlate Location & Received Info” block 256, the location of the consumer, which may correspond to the location of vehicle 52 or a device 101-108 and in the following example is onboard display 103, is correlated (see 154, FIG. 3) with the location of known billboards such as billboard 110 based upon information stored in DB 136 (FIG. 2). The location of onboard display 103 may be determined by GPS information, triangulation among stations (not shown) in to wireless system such as wireless system 109 (FIG. 2) or any other available means (see 153, FIG. 3) and transmitted in conjunction with the query. In addition, billboard 110 may be identified from a cluster of display devices.

Location may also be determined by means of an identification code displayed on billboard 110 and manually or orally entered by the consumer or sent electronically from billboard 110 to the device used for locating the billboard. For example, message 112 could be a numeric, GPS or alias code that represents both the latitude and longitude of billboard 110 and a particular side of billboard 110 or identified a particular billboard 110 within a duster of billboards.

In an alternative embodiment, location verification may be conducted. For example, the consumer who initiated the query may be sent a message to verify that the correct billboard has been identified. In the event that the consumer responds with an indication that the correct billboard has not been identified, PAIDS 134 may conduct a search of DB 136 to determine another likely candidate, request verification of the likely candidate and the process would continue until billboard 110 has been correctly identified.

In addition to physical location, direction of travel, or “heading,” and predictions of possible paths may also be generated by location module 153 using any currently available or yet to be developed technology. Based upon the location of onboard display 103, a determination is made as to a particular display device in proximity to onboard display 103. Based upon calculations of heading, a specific face of billboard 110 may also be determined. In addition, the particular billboard 110 may be determined by information included in data received from onboard display 103. For example, billboard 110 may display an identification code that a user enters, either manually, by audio command or sent electronically, on onboard display 103 and the code corresponds to a particular display device and message. In an alternative embodiment, the consumer may be asked to clarify the particular display device by indicating a name of the business, an alias or identification code printed on the display device, direction of travel, e.g. east or west bound, or a highway mileage marker or exit number. These techniques may be particularly helpful with respect to a mobile display device such as one mounted or painted on a truck or dirigible, in or on a bus or on a banner towed behind an airplane or dirigible.

It should also be noted that in addition to location information, information such as automotive diagnostic information may be received from, in this example, onboard display 103. As described above, one example of an onboard vehicle communication device 105 such as ONSTAR® may include a transmitter that is able to communicate computer diagnostic information. Using such computer diagnostic information, such as, but not limited to, fuel, oil, tire pressure, and battery charge warnings.

Although, many display devices may be in a fixed position such that data may simply be stored in and retrieved from DB 136, the disclosed technology also includes provisions for mobile display devices such as moveable warning signs and mobile advertising vehicles from a list of those on the land, air and water fir which the location may also be determined by technology including, but are not limited to the global positioning system (GPS) information transmitted by GPS satellites 114 (FIG. 2), triangulation based upon multiple signals to various communication facilities such as cellular telephone towers or information input by the consumer manually, audibly, sent electronically or other means including, but not limited to, motion and shaking sensors.

During processing associated with a “Request for Information (Info)?” block 258, a determination is made as to whether or not the query received during processing associated with block 254 is a request for information. If so, during processing associated with a “Send Info” block 260, information related to, in the example, billboard 110 is transmitted to onboard display 103. Such information may be visual, textual, email and/or aural or any combination of mediums supported by the particular device that originated the query received during processing associated with block 254. Examples of request for information may include questions concerning prices, special offers, location and contact information such as a telephone number or email address of a restaurant or business office, directions, identity of hazards and so on. Examples of information provided may be, but are not limited to, timely offers for products or services, websites for additional information, warnings, printable coupons, electronic coupons, coupon codes, directions, speed limits, distance to particular locations, contact numbers, confirmation of an offer or reservation, load limits, height limits, amount of a toll that needs to be paid and so on. Information may be retrieved from data stored in conjunction with PAIDS 134 (see 161, FIG. 3) or the result of a query and response from an entity, such as government 136 (FIG. 2) and business 138 (FIG. 2), that corresponds to billboard 110. In addition, information provided may be relevant to information such as, but not limited to, fuel, oil, tire pressure, and battery charge warnings, such that the consumer is directed to a specific business that is able to handle a current situation or directed to a pre-entered preferred provider list (see 161, FIG. 3). For example, employing a location sent by mobile telephone 101 and information on remaining fuel, gas stations within the range of the available fuel may be determined and information concerning the gas stations within range transmitted to onboard display 103.

If during processing associated with block 258, a determination that the query is not a request for information, during processing associated with a “Request for Offer?” block 262, a determination is made as to whether or not the query received during processing associated with block 254, is a request for an offer. If so, during processing associated with a “Generate Offer” block 264, an offer related to the information displayed on billboard 110 is generated. In addition to an offer for is product or service, an electronic coupon relating to the product or service may be transmitted. For example, an electronic coupon and a link to a website may be transmitted to vehicle 52 enabling the consumer to purchase a product or service on the website by using the electronic coupon or enable the consumer to receive a coupon to be used at a later date.

As with providing information (see 260), an offer may be relevant to a current situation such as low oil or tire pressure. Such an offer may be generated by PAIDS 134 based upon information stored by PAIDS 134 (see 161, FIG. 3) or a query to and response from the entity, such as government 136 or business 138, associated with billboard 110. For example, PAIDS 134 may store different prices for hotel, rooms or gasoline based upon the time of day or, in the alternative, may communicate with government 136 or business 138 to enable personnel or processing components to generate an offer based upon current conditions. In addition, an offer may be time dependent such as “good for the next hour.” During processing associated with a “Transmit Offer” block 266, the offer generated during processing associated with block 264 is transmitted to the requesting device, which in this example is onboard display 103. It should be understood that there are many potential methods for delivering an offer. For example, a user may designate that messages and offers be delivered as text messages, audio messages, pre-entered email addresses either in addition to or instead of any available visual display. In addition, a transmitted offer may be intended for use in the future rather than at the current time. Such messages may include additional information than that which is displayed. For example, a Property for Sale sign may transmit a sales price and terms that are not included on the sign.

If during processing associated with block 262, a determination that the query is not a request for an offer, during processing associated with a “Offer Acceptance?” block 268, a determination is made as to whether or not the query received during processing associated with block 254, is a response to an offer either transmitted during processing associated with block 266 or included in information sent during processing associated with block 260. In the alternative, message 111 or 112 (FIG. 2) may present an offer to which a user of onboard display 103 may respond. If so, during processing associated with a “Notify Business” block 270, a business that corresponds to the accepted offer is notified. It should be noted that, although block 270 only refers to businesses, government 136 may also present and accept an offer of some type but, for the sake of simplicity only a business is described. For example, the disclosed technology may be employed to collect tolls and a park entry fee, notify consumers of low balances on toll cards and recharge toll cards. During processing associated with an “Implement Billing” block 272, PAIDS 134 may implement a billing procedure (see 157 FIG. 3). Of course, a business or government) notified during processing associated with block 270 may also be responsible for any billing procedures instead of or in addition to PAIDS 134.

If, during processing associated with block 268, a determination that the query is not an offer acceptance, control proceeds to a “Throw Exception?” block 274. During processing associated with block 274, appropriate measures are taken to handle a communication that does not fit into one of the defined categories, request for information, request for offer or offer acceptance. It should be noted that other categories of processing may be defined but for the sake of simplicity only three (3) are illustrated and described.

During processing associated with block 260, information has been transmitted, during processing associated with block 266, an offer has been transmitted, during processing associated with block 274, and offer has been accepted and invoiced, or during processing associated with block 270, an exception has been generated, control returns to block 254, during which PAIDS 134 awaits the next query and processing continues as described above. Finally, process 250 is halted by means of an interrupt 276, which passes control to an “End Operate PAID” block 279 in which process 250 is complete. Interrupt 276 is typically generated when the OS or computing system, etc. of which process 250 is a part is itself halted. An administrator may also manually generate interrupt 276. During normal operation, process 250 continuously loops through the blocks 254, 256, 258, 260, 262, 264, 266, 268, 270, 272 and 274, processing queries as they are received.

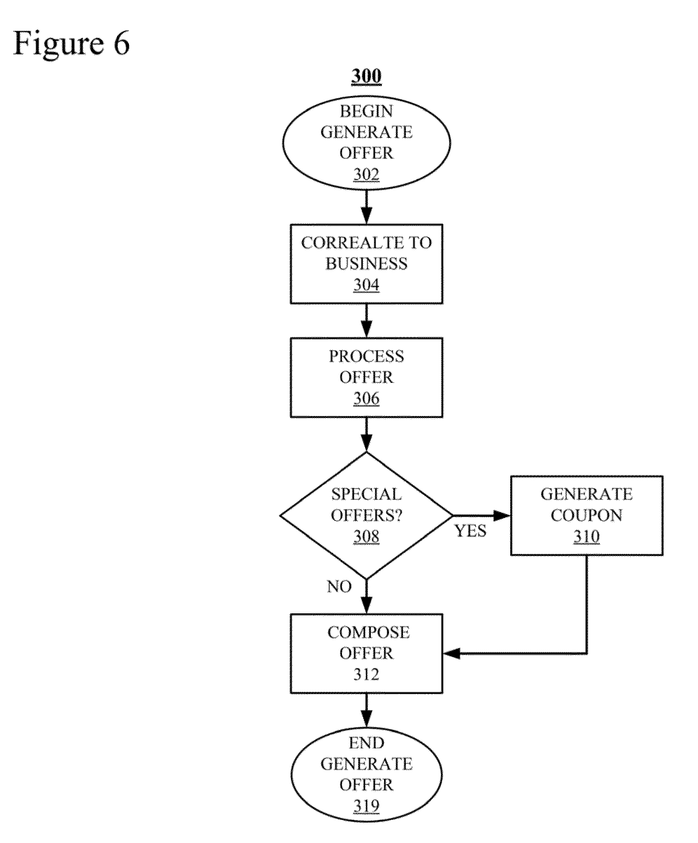

FIG. 6 is a flowchart of one example of a Generate Offer Data process 300 that may implement aspects of the claimed subject matter. Like processes 200 and 250, in this example, process 300 is stored in executable logic 164 (FIG. 3) in conjunction with PAIDS 134 (FIGS. 1-3) on CRSM 132 (FIG. 2) of server 122 (FIG. 2) and executes on one or more processors (not shown) of CPU 124 (FIG. 2). Process 300 corresponds to block 264 of FIG. 5 and is described using billboard 110 (FIG. 2) as a display device and onboard display 103 as the source of a user's query (see 254, FIG. 5).

Process 300 stalls in a “Begin Generate Offer” block 302 and proceeds immediately to a “Correlate to Business” block 304. During processing associated with block 304, process 300 determines which business 138 or governmental agency 136 corresponds to the display device, in this example billboard 110 (see 154, FIG. 3). As explained above in conjunction with FIG. 3, information about the various display devices is stored in user configuration 161 of data module 158.

During processing associated with a “Process Offer” block 306, information concerning the billboard, e.g., particular messages 109 and 110 (FIG. 2) currently displayed, and information about the business are employed to generate an offer for a product or service. For example, if the business is a hotel the room price offered may be related to the hotel's current occupancy status, which may be periodically updated in user configuration 161 or determined from a query transmitted and responded to from the hotel once the request for offer has been received and identified. If the business is a restaurant, an offer may depend only on menu information stored in user configuration 161 and the time of day, i.e. breakfast, lunch or dinner time.

During processing associated with a “Special Offers?” block 308, a determination is made as to whether or not there are any relevant special offers that may apply. In this example, the existence of a special offer generates a coupon during processing associated with a “Generate Coupon” block 310. It should be noted that there are many other delivery options that may be employed to implement special offers, such as but not limited to a discount code, but that coupons are just a single example. Once a coupon has been generated during processing associated with block 310 or, if, during processing associated with block 308, a determination is made that no special offers apply, control proceeds to a “Compose Offer” block 312. During processing associated with block 312, the information gathered and processed during blocks 304, 306, 308 and potentially 310 are employed to generate a specific offer, possibly including a coupon, for transmission to onboard display 103. As explained above, the actual form of the offer may be visual, textual or aural, depending upon the type of offer and type of device to which the offer is ultimately transmitted. Finally, control proceeds to an “End Generate Offer” block 319 during which process 300 is complete.

FIG. 7 is a flowchart of a Sensor Detection process 350 that may implement aspects of the claimed subject matter to address a problem identified by a sensor (not shown) on vehicle 52 (FIG. 1). In this example, logic associated process 350 is stored on CRSM 132 (FIG. 2) and executed on CPU 124 (FIG. 2) of server 122 (FIG. 2) in conjunction with PAIDS 134 (FIGS. 1-3).

Process 350 starts in a “Begin Sensor Detection” block 352 and proceeds immediately to a “Receive Alert” block 354. In this example, a detection system (not shown) in vehicle 52 has identified a problem with vehicle 52 based upon a reading transmitted from a sensor (not shown). One with skill in the relevant arts should appreciate both the many types of sensors available in vehicles and the manner in which they are implemented, i.e. typically with memory and processors incorporated into the vehicle. For the sale of simplicity, the elements of a vehicle sensor detection system are not illustrated. In this example, a sensor in vehicle 52 has detected that vehicle 52 has a tire with low pressure and process 350 is receiving an alert transmitted to PAIDS 134.

During processing associated with “Receive Alert” block 354, PAIDS 134 receives the low tire pressure alert transmitted by vehicle 52. In addition to the tire pressure warning, the received alert includes information from vehicle 52 that enables PAIDS 134 to determine the location of vehicle 52 (see 153, FIG. 3). During processing associated with an “Analyze Location and Alert” block 356, the vehicle location and type of alert are correlated. During processing, associated with an “Identify Businesses” block 358, DB 136 (FIG. 2) is searched for businesses near the current location of vehicle 52 that may be appropriate to address the issue identified by the alert from vehicle 52. For example, in response to a low tire pressure warning, PAIDS 134 may identify service stations that have air pumps as well as service stations that can fix a flat tire. In addition, a list of businesses may be filtered based upon specified consumer or user preferences (see 161, FIG. 3) and the particular circumstances of the warning. For example, a low fuel warning may initiate a filter of available gas stations based upon a calculation of the vehicle's remaining range and whether or not any particular gas station is within range.

During processing associated with as “Transmit Business Info” block 360, a list of the businesses identified during processing associated with block 358 is transmitted to vehicle 52. In addition to the identity of the businesses, a summary of the types of issues that are able to be handled by each business may also be transmitted. For example, one service station may be listed or not listed based upon the availability/unavailability of an air pump, a second station may list an available air pump and a third station may list flat tire repair. During processing associated with a “Receive Selection” block 362, a selection of one of the businesses identified during processing associated with block 358 from the list transmitted during processing associated with block 360 is transmitted to PAIDS 134. Such a selection may be made by the consumer in vehicle 52 by means such as, but not limited to, a touch screen, speech recognition, keyboard entry, mobile telephone motion or shake and so on.

During processing associated with a “Transmit Directions” block 364, directions to the business identified during processing associated with block 362 are transmitted to a device in vehicle. It should be noted that the device that receives directions may not be the same device that has transmitted the alert or register the business selection. In addition, directions may be verbal, textual, visual, an email message or simply entered into a GPS device of vehicle 52 or a device such as a smart phone or mobile computing device. In an alternative embodiment, the consumer may be able to select whether or not to receive directions. Finally, during processing associated with an “End Sensor Detection” block 369, process 350 is complete.

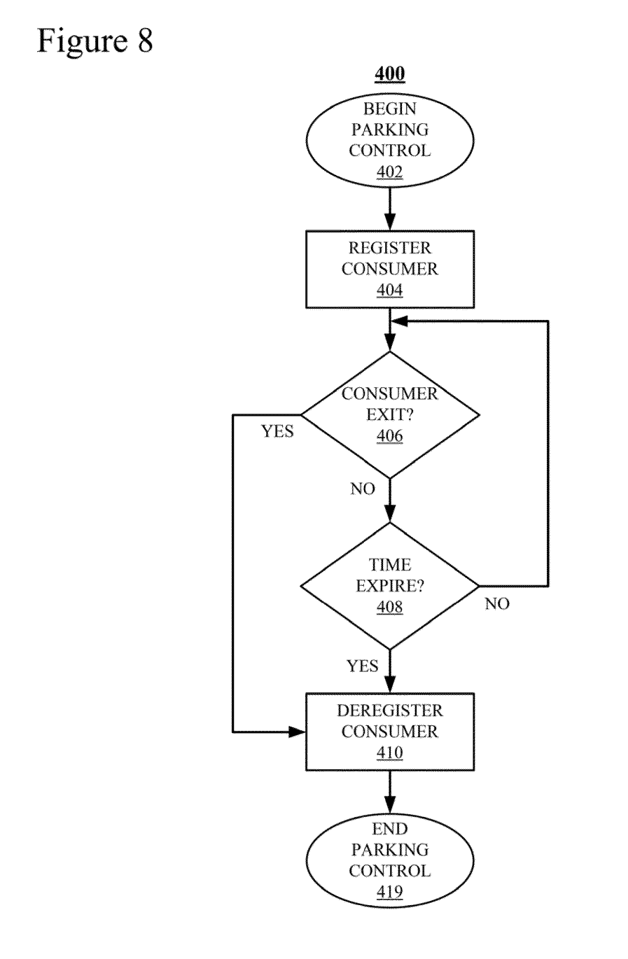

FIG. 8 is a flowchart of a Parking Control process 400 that may implement aspects of the claimed subject matter. In this example, logic associated with process 400 is stored on CRSM 132 (FIG. 2) and executed on CPU 124 (FIG. 2) of server 122 (FIG. 2) in conjunction with PAIDS 134 (FIGS. 1-3).

Process 400 starts in a “Begin Parking Control” block 402 and proceeds immediately to a “Register Consumer” block 494. During processing associated with 404, a consumer may use one of mobile devices 101-108 (FIG. 2) to “register” for some business resource such as, but not limited to, a parking space or a restaurant table. For example, an application on mobile phone 101 may enable the consumer to identify a parking spot. The location of the parking spot may be determined, automatically by sensors (not shown) associated with the parking spot or entered by the consumer via an application such as a mobile application, a WiFi or Bluetooth connection. In the alternative, the consumer may enter a business that corresponds to the parking spot and provide a clerk with parking information and consumer information. Consumer information and spot or table information may also be provided by a valet, by presenting a customer or loyalty card that is encoded with the information or with the relevant information that has been pre-entered in a mobile device, entered via a motion or shaking based system. For example, the business might be a coffee shop and the customer card might be a loyalty card associated a particular consumer who frequents the coffee shop. It should be noted that, as explained above, the term “customer” applies to businesses that employ the claim subject matter and the term “consumer” applies to patrons of the customers.

During processing associated with a “Register Consumer” block 404, data associated with the consumer is entered in DB 136 (FIG. 2) by a person associated with the business. Such data may include the identity of the consumer as well as the parking spot occupied by the consumer's vehicle 52 (FIG. 1). Information about the parking spot may be verbally given to the business by the consumer. In an alternative embodiment, a consumer card is not necessary; the consumer may verbally report both their identity and the location of the parking spot.

During processing associated with a “Consumer Exit?” block 406, a determination is made as to whether or not the consumer that was registered during processing associated with 404 has left the business. If so, control proceeds to a “Time Expire?” block 408. During processing associated with block 408, a preset timer (not shown) that allots a maximum amount of parking time to each consumer set in conjunction with the registering during processing associated with 404 is evaluated. If the timer has expired, control proceeds to a “Deregister Customer” block 410. If a determination is made during processing associated with block 406 that the customer has exited the business, control proceeds to block 410 and the consumer is deregistered. In addition to deregistering a consumer, one or more of the business, consumer or third party may be notified. If, during processing associated with block 410, a determination is made that the timer has not expired, control returns to block 406 and control proceeds as described above.

In an alternative embodiment, there may be two different timers, one related to the amount of time since a determination that the consumer has exited the business and another related to a predetermined maximum amount of parking time. For example, a consumer may be give an hour after exiting the business before a de-registration process is implemented. Finally, during processing associated with an “End Parking Control” block 419, process 400 is complete.

Process 400 and the disclosed technology enable a business to effectively manage resources such as, but not limited to, parking spots and restaurant tables. In one embodiment, parking spaces in a parking lot may each have a sign that uniquely identifies the corresponding spot. A consumer using a parking spot can enter location information and be identified as a legitimate user or the spot, in addition to have vehicle identification information such as license, color and make either entered manually or retrieved from records corresponding to the consumer in a database. A particular parking spot may also be correlated to particular hotel room or restaurant/bar table or a seat(s) in other venues. Particular spots may be designated as handicapped, leased to specific consumers or designated as employee spots. In that case by employing the disclosed technology, a business can correlate a particular consumer with a specific car and parking spot and determine whether or not a vehicle in any particular spot is authorized before taking remedial measures. Such remedial measures may include notifying a towing company or accessing a charge.

The terminology used herein is for the purpose of describing particular embodiments only and is not intended to be limiting of the invention. As used herein, the singular forms “a”, an and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the arm disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
receiving one or more messages from a first mobile device;
calculating a location of the first mobile device based upon the one or more messages;
correlating the location with a display device in proximity to the first mobile device;
generating a second message, based upon stored data associated with the display device, comprising to one or more of a data list, the data list comprising:
information corresponding to the display device;
information corresponding to a product;
information corresponding to a service;
a location of an entity corresponding to the display device; and
an offer associated with a one or more of the product, service and information corresponding to the display device;
wherein the entity is one of an entity list, comprising;
a business;
a service;
as non-profit organization; and
a governmental, agency; and
transmitting the second message for display to a user associated with the first mobile device.

2. The method of claim 1, further comprising calculating a heading of the first mobile device based upon the one or more messages, wherein the correlating the location with the display device in proximity to the first mobile device also takes into account the heading.

3. The method of claim 1, wherein the second message is one or more of a message list comprising:
an aural message,
an email;
a visually displayed message; and
a text message.

4. The method of claim 1, further comprising selecting the display device from a cluster of display devices based upon a pre-defined user-preference.

5. The method of claim 1, wherein the display device is one of a plurality of display devices within a cluster of display devices.

6. The method of claim 1, wherein the display device is one of a display list, the display list comprising:
billboard;
a sign;
a display advertisement;
a pylon;
a video display;
an alpha-numeric display; and
a mobile display.

7. The method of claim 1, wherein the one or more messages include a request for an offer and the second message is an offer associated with the entity corresponding to the display device, further comprising:
receiving a third message corresponding to an acceptance of the offer; and
implementing delivery of an offer associated with a one or more of the product, service and information corresponding to the display device in response to receiving the third message.

8. The method of claim 1, wherein the calculating the location and heading is based upon one or more of items on a location list, the location list comprising:
GPS information;
signal triangulation; and
user entered data.

9. The method of claim 1,
wherein the one or more messages include information relating to a condition of a vehicle; and
wherein an offer associated with a one or more of the product, service and information corresponding to the display device is also correlated with the information related to the condition of the vehicle.

10. The method of claim 9, wherein the information relating to the condition of the vehicle is generated by as sensor associated with the vehicle, wherein the sensor is one of a condition list comprising:
an oil pressure indicator;
an oil level indicator;
an oil change indicator;
a tire pressure indicator;
a battery charge indicator;
an engine status indicator;
light sensor;
a brake sensor;
a transmission sensor;
a sensor that detects a defective air bag;
an engine service indicator;
a computer generated alert;
a temperature sensor;
a speed sensor; and
a catalytic converter sensor.

11. The method of claim 1,
wherein the second message is transmitted to a second mobile device corresponding to the user of the first device; and
wherein the second mobile device is a different device than the first device.

12. The method of claim 1, wherein the second message comprises a time sensitive offer.

13. An apparatus comprising:
a processor;
a computer readable storage medium coupled to the processor; and
logic, stores on the computer readable storage medium and executed on the processor, for:
receiving one or more messages from a first mobile device;
calculating a location and heading based upon the one or more messages;
correlating the location and heading with a display device in proximity to the first mobile device;
generating a second message, based upon stored data associated with the display device, comprising information related to one or more data list, the data list comprising:
information corresponding to the display device;
information corresponding to a product;
information corresponding to a service;
a location of an entity corresponding to the display device; wherein the entity is one of an entity list, comprising;
a business;
service; and
a governmental agency; and
an offer associated with a one or more of the product, service and information corresponding to the display device; and
transmitting the second message for presentation to a user corresponding to the first mobile device.

14. The apparatus of claim 13, wherein the second message is one or more of a message list comprising:
an aural message,
an email;
a visually displayed message; and
a text message.

15. The apparatus of claim 13, the logic further comprising logic for selecting the display device form a cluster of display devices based upon a pre-defined user-preference.

16. The apparatus of claim 13, wherein the display device is one of a plurality of display devices within a cluster of display devices.

17. The apparatus of claim 13, wherein the display device is one of a display list, the display list comprising:
a billboard;
a sign;
a display advertisement;
a pylon;
a video display;
an alpha-numeric display; and
a mobile display.

18. The apparatus of claim 13 wherein the one or more messages include a request for an offer and the second message is an offer associated with the entity; further comprising:
receiving a third message corresponding to an acceptance of the offer; and
implementing delivery of an offer associated with a one or more of the product, service and information corresponding to the display device in response to receiving the third message.

19. The apparatus of claim 13, wherein the logic for calculating the location and heading employs one or more of items on a location list, the location list comprising:
GPS information;
signal triangulation; and
user entered data.

20. The apparatus of claim 13,
wherein the one or more messages comprise information relating to a condition of a vehicle; and
wherein the entity is also correlated with the information related to the condition of the vehicle.

21. The apparatus of claim 20, wherein the information relating to the condition of the vehicle is generated by a sensor associated with the vehicle, wherein the sensor is one of a condition list comprising:
an oil pressure indicator;
an oil level indicator;
an oil change indicator;
a tire pressure indicator;
a battery charge indicator;
an engine status indicator;
a light sensor;
a brake sensor;
a transmission sensor;
a sensor that detects a defective air bag;
an engine service indicator;
a computer generated alert;
a temperature sensor;
a speed sensor; and
a catalytic converter sensor.

22. The apparatus of claim 13,
wherein the second message is transmitted to a second mobile device corresponding to the user of the first mobile device; and
wherein the second mobile device is a different device than the first mobile device.

23. The apparatus of claim 13, wherein the second message comprises a time sensitive offer.

24. A method, comprising:
receiving a first message from a device associated with a vehicle, wherein the first message includes information relating to a current condition of the vehicle;
calculating a location and heading of the vehicle based upon the first message;
correlating the location and heading of the vehicle with a location of one or more businesses in proximity to the vehicle, wherein the businesses are capable of addressing the current condition of the vehicle;
generating a second message comprising an identity of the businesses; and
transmitting the second message for presentation to a user corresponding to the vehicle.

25. The method of claim 24, further comprising:
receiving a choice from the user of a particular business of the one or more businesses; and
transmitting directions to the particular business for display to the user.

26. The method of claim 24, further comprising:
filtering the one or more business based upon pre-defined preferences to produce a list of preferred businesses; and
generating the second message from the list of preferred businesses.

27. The method of claim 24, further comprising:
filtering the one or more business based upon to a current capability of the vehicle based upon the current condition of the vehicle to produce a filtered list of businesses; and
generating the second message based upon the filtered list.

28. The method of claim 24, wherein the information relating to the current condition to the vehicle is generated by a sensor associated with the vehicle, wherein the sensor is one of a condition list comprising:
an oil pressure indicator;
an oil level indicator;
an oil change indicator;
a tire pressure indicator;
a battery charge indicator;
an engine status indicator;
a light sensor;
a brake sensor;
a transmission sensor;
an air bag sensor;
an engine service indicator;
a temperature sensor;
a computer generated alert;
a speed sensor; and
a catalytic converter sensor.

29. A method, comprising:
registering a vehicle with a business;
correlating, based upon the registering, the vehicle with a resource associated with the business;
monitoring usage of the resource with respect to the vehicle;
detecting that the usage has exceeded a predetermined limit; and
in response to the detecting, notifying one or more of the business, a customer and a third party that the usage has exceeded the predetermined limit.

30. The method of claim 29, the registering comprising receiving a signal from the vehicle a signal that identifies the vehicle and associates the resource with the vehicle.

31. The method of claim 29, the registering comprising:
receiving a signal from the resource that identifies the resource; and
associating the resource with the vehicle.

32. The method of claim 29, the registering comprising reading information from a card.

33. The method of claim 29, the registering comprising retrieving pre-stored information corresponding to the vehicle.

34. The method of claim 29, the registering comprising manually entering information identifying the resource and the vehicle.

35. The method of claim 29, wherein the resource is one or more of a resource list, comprising:
a parking spot associated with the business;
a customer table associated with the business;
a seat associated with a business; and
a room in a hotel.

36. The method of claim 29, further comprising notifying, in response to the detecting, one or more of a notification list that the usage has exceeded the predetermined limit, the notification list comprising:
a business;
a customer; and
a third party;

37. A computer program product embodied in a computer readable storage medium for delivering information to assist a user of a vehicle, the computer program product comprising the programming instructions for:
receiving a first message from a device of the vehicle;
calculating a location and a heading of the vehicle based upon the first message;
correlating the location and the heading of the vehicle with the display device in proximity to the vehicle;
generating a second message based upon stored data associated with the display device, wherein the stored data comprises one or more of the following:
information corresponding to the display device;
information corresponding to a product;
information corresponding to a service;
a location of an entity corresponding to the display device; and
an offer associated with one or more of the following:
a product;
a service; and
the information corresponding to the display device; and
transmitting the second message for display to the user of the vehicle.

38. The computer program product of claim 37, wherein the entity is one of the following:
a business;
a service;
a non-profit organization; and
a governmental agency.

39. A computer program product embodied in a computer readable storage medium for delivering information to assist a user of a vehicle, the computer program product comprising the programming instructions for:
receiving a first message from a device of the vehicle, wherein the first message includes information relating to a current condition of the vehicle;
calculating a location and a heading of the vehicle based upon the first message;
correlating the location and the heading of the vehicle with a location of one or more businesses in proximity to the vehicle, wherein the one or more businesses are capable of addressing the current condition of the vehicle;
generating a second message comprising one or more identities of the one or more businesses; and
transmitting the second message for display to the user of the vehicle.

40. A computer program product embodied in a computer readable storage medium for ensuring that a resource of a business is being used by patrons of the business, the computer program product comprising the programming instructions for:
registering a vehicle with the business;
correlating, based upon the registering, the vehicle with a resource associated with the business;
monitoring usage of the resource with respect to the vehicle;
detecting that the usage has exceeded a predetermined limit; and
notifying one or more of the business, consumer or third party that the usage has exceeded the predetermined limit in response to the detecting.

41. The computer program product as recited in claim 40, wherein the resource comprises one of the following:
a parking spot;
a customer table;
a seat; and
a room in a hotel.
